(19) United States
(12) Patent Application Publication
(10) Pub. No.: US 2026/0237206 A1
(43) Pub. Date: Aug. 13, 2026

(54) GENERATING HIERARCHICAL OBJECT MASKS FROM DIGITAL IMAGES USING A NEURAL NETWORK CONDITIONED ON VARYING SEMANTIC LEVELS

(71) Applicant: Adobe Inc., San Jose, CA (US)

(72) Inventors: Brian Price, San Jose, CA (US); Joshua Myers-Dean, Boulder, CO (US); Yifei Fan, Santa Clara, CA (US); Kangning Liu, San Jose, CA (US); Jason Wen Yong Kuen, Santa Clara, CA (US)

(21) Appl. No.: 19/053,166

(22) Filed: Feb. 13, 2025

(51) Int. Cl. G06V 20/40; G06V 10/778; G06V 10/82; G06V 20/70

(52) U.S. Cl. CPC G06V 20/41; G06V 10/7788; G06V 10/82; G06V 20/70

(57) ABSTRACT

The present disclosure relates to systems, methods, and non-transitory computer-readable media that generate a hierarchy of masks for a selected object within a digital image. For example, in some embodiments, the disclosed systems receive a digital image and user input selecting one or more pixels within an object portrayed therein. Using a segmentation neural network, the disclosed systems determine a parent token corresponding to a first semantic level for the object and a child token corresponding to a second semantic level for the object that is hierarchically lower than the first semantic level. The disclosed systems further generate, using the segmentation neural network and from the tokens, a first mask that corresponds to the first semantic level and a second mask that corresponds to the second semantic level. The disclosed systems provide, for display, at least one of the first mask or the second mask.

### BACKGROUND

Recent years have seen significant advancement in hardware and software platforms for editing digital images. Indeed, as digital images have become increasingly ubiquitous, systems have developed to facilitate the manipulation of the content within such images or videos. To illustrate, many systems offer tools for generating segmentation masks for objects portrayed within an image. Some systems use the masks to modify the content within an image, such as by modifying a portrayed object or the area surrounding a portrayed object.

### SUMMARY

One or more embodiments described herein provide benefits and/or solve one or more problems in the art with systems, methods, and non-transitory computer-readable media that use a neural network to flexibly and efficiently generate a hierarchy of masks for an object within a digital image. For instance, in one or more embodiments, a system uses a neural network to return a set of masks in response to a user selection of one or more pixels within an object portrayed in a digital image. In some cases, each mask in the set corresponds to a different semantic level for the object (e.g., an object level, a part level, a subpart level, or a group level). In some embodiments, the system conditions the neural network to output the set of masks using various training techniques, including training labels from model generated segmentation outputs, click distribution, and/or a contrastive-based loss function. Further, in certain cases, the system configures a graphical user interface to present the set of masks coherently. In this manner, the disclosed systems flexibly perform consistent hierarchical segmentation for various semantic levels associated with pixels of digital images selected by a single user interaction.

Additional features and advantages of one or more embodiments of the present disclosure are outlined in the description which follows, and in part will be obvious from the description, or are learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a hierarchical segmentation system operates in accordance with one or more embodiments;

FIG. 2 illustrates, the hierarchical segmentation system generating a hierarchy of masks for an object portrayed in a digital image in accordance with one or more embodiments;

FIG. 3 illustrates using a segmentation neural network to generate a plurality of masks at various semantic levels in accordance with one or more embodiments;

FIGS. 4A-4C illustrate training a segmentation neural network to generate a hierarchy of masks for an object portrayed in a digital image in accordance with one or more embodiments;

FIGS. 5A-5C illustrate graphical user interface configurations used by the hierarchical segmentation system to present a hierarchy of masks in accordance with one or more embodiments;

FIG. 6 illustrates an example schematic diagram of a hierarchical segmentation system in accordance with one or more embodiments;

FIG. 7 illustrates a flowchart of a series of acts for generating a hierarchy of masks for a selected object in a digital image in accordance with one or more embodiments; and

FIG. 8 illustrates a block diagram of an exemplary computing device in accordance with one or more embodiments.

### DETAILED DESCRIPTION

One or more embodiments described herein include a hierarchical segmentation system that flexibly generates segmentation masks for an object of a digital image at different semantic levels in response to a selection of a pixel within the object. To illustrate, in one or more embodiments, the hierarchical segmentation system conditions a neural network to segment an object at different semantic levels in accordance with a location of a selected pixel. In some instances, the hierarchical segmentation system conditions the neural network using training labels for images at the different semantic levels, training selections of pixels across various portions of objects portrayed in the images, and/or a contrastive-based loss function that enables the neural network to differentiate between different portions of the same object. In some embodiments, via the conditioning, the neural network learns to generate internal representations (e.g., tokens) indicative of the semantic levels. Thus, in some cases, the hierarchical segmentation system implements the conditioned neural network to respond to a single user interaction with an object by generating a hierarchy of masks. The hierarchical segmentation system provides the masks for display via various graphical user interface configurations in various embodiments.

To illustrate, in one or more embodiments, the hierarchical segmentation system receives a digital image and user input selecting one or more pixels within an object portrayed in the digital image. The hierarchical segmentation system determines, using a segmentation neural network and based on the user input, a parent token corresponding to a first semantic level for the object and a child token corresponding to a second semantic level for the object that is hierarchically lower than the first semantic level. Using the segmentation neural network, the hierarchical segmentation system generates a first mask that corresponds to the first semantic level and a second mask that corresponds to the second semantic level from the parent token and the child token. The hierarchical segmentation system further provides at least one of the first mask or the second mask for display.

As just indicated, in one or more embodiments, the hierarchical segmentation system generates a hierarchy of masks for an object portrayed in a digital image in response to a user selection of a pixel within the object. In particular, the hierarchical segmentation system generates a set of masks, where each mask corresponds to a different semantic level for the object. As an example, in some embodiments, the hierarchical segmentation system generates an object-level mask, a part-level mask, a subpart-level mask, and/or a group-level mask for the object.

As further mentioned, in some embodiments, the hierarchical segmentation system generates the hierarchy of masks based on the location of the selected pixel within the object. In particular, in some implementations, the hierarchical segmentation system generates different sets of masks for different locations that have been selected within an object. To illustrate, in some cases, the hierarchical segmentation system includes a part-level mask for a first part of an object where the selected pixel is located within the first part or includes a part-level mask for a second part of the object where the selected pixel is located within the second part. Thus, in certain embodiments, the hierarchical segmentation system distinguishes between different parts of the same object or different subparts of the same part.

Additionally, as mentioned, in some implementations, the hierarchical segmentation system uses a segmentation neural network to generate the masks in response to the user selection of the pixel. For instance, in some cases, the hierarchical segmentation system uses a segmentation neural network to generate tokens representing the semantic levels and generate the masks from the tokens. In some instances, the tokens indicate the parent-child semantic relationships among the masks that are generated.

In one or more embodiments, the hierarchical segmentation system conditions the segmentation neural network to generate hierarchies of masks in response to user selections. For instance, in some cases, the hierarchical segmentation system conditions the segmentation neural network to learn the internal representations (i.e., the tokens) that allow for the generation of a hierarchy of masks for an object within a digital image.

To illustrate, in some cases, the hierarchical segmentation system builds a dataset of training labels that correspond to various semantic levels. For example, in some cases, the hierarchical segmentation system uses a pre-trained segmentation neural network to generate segmentation outputs from a set of training images that already have associated object-level training labels (e.g., labels determined manually) for the objects portrayed therein. The hierarchical segmentation system further determines additional training labels (e.g., part-level and/or subpart-level training labels) by comparing the segmentation outputs to the objects.

In some embodiments, the hierarchical segmentation system intentionally distributes pixel selections during training to ensure that different parts of a given object and/or different subparts of a given part are sufficiently represented within the training inputs. Further, in some cases, the hierarchical segmentation system uses a contrastive-based loss function to enable the segmentation neural network to differentiate between different parts of the same object and/or different subparts of the same part.

Additionally, as mentioned above, the hierarchical segmentation system provides the generated masks for display within various graphical user interface configurations in various embodiments. For instance, in some cases, the hierarchical segmentation system provides the full set of masks simultaneously or provides the masks one at a time. For example, in some embodiments, the hierarchical segmentation system provides a mask based on a user-selected semantic-level mode or enables a user to view the full set of masks by scrolling through the semantic levels one at a time.

The hierarchical segmentation system provides advantages over conventional systems. Indeed, conventional segmentation systems suffer from several technological shortcomings that result in in inflexible and inefficient operation. To illustrate, many conventional systems are inflexible in that they fail to target the semantic hierarchy of an object portrayed in a digital image when performing segmentation. While some conventional systems do generate multiple masks that may be part of a semantic hierarchy, they fail to target such results, leading to inconsistency in the segmentation. For instance, some systems perform segmentation based on the scale of objects in an image, potentially leading to mask outputs that meet the scale requirements but are unrelated semantically. Other systems generate results that include duplicate masks or masks that are relatively useless (e.g., a mask for an arbitrary portion of an object).

Additionally, many conventional segmentation systems fail to operate efficiently. For example, some conventional systems enable the segmentation of objects at different semantic levels but require a significant number of user inputs to do so. To illustrate, some systems respond to a user selection of an object within an image by generating an object-level mask for the object. To generate an additional mask corresponding to a different semantic level, such systems typically require one or more additional user interactions, such as by requiring multiple additional clicks on a particular part of the object to indicate that the part-level mask is intended or additional clicks (e.g., negative clicks) on other parts of the object to indicate that those parts are intended to be omitted or removed from the mask. Some systems require multiple interactions to generate a single group-level mask, such as by requiring a click on each object of the object group to indicate an intention to incorporate that object. Thus, these systems often require a user to interact with a graphical user interface displaying a digital image multiple times to produce masks corresponding to different semantic levels.

One or more embodiments of the hierarchical segmentation system operate with improved flexibility when compared to conventional systems. For instance, by using a segmentation neural network that implements learned internal representations (i.e., tokens) of semantic levels, the hierarchical segmentation system more flexibly targets the semantic hierarchy associated with an object selected within a digital image. Thus, the hierarchical segmentation system more flexibly generates masks that correspond to the semantic hierarchy. Further, the hierarchical segmentation system generates masks that are part of the semantic hierarchy of an object more consistently than do many conventional systems.

Additionally, one or more embodiments of the hierarchical segmentation system operate with improved efficiency when compared to conventional systems. In particular, the hierarchical segmentation system reduces the number of interactions typically required by conventional systems to generate a set of masks for an object of a digital image. Indeed, in many cases, the hierarchical segmentation system generates multiple masks corresponding to different semantic levels in response to a single click selecting one or more pixels within an object.

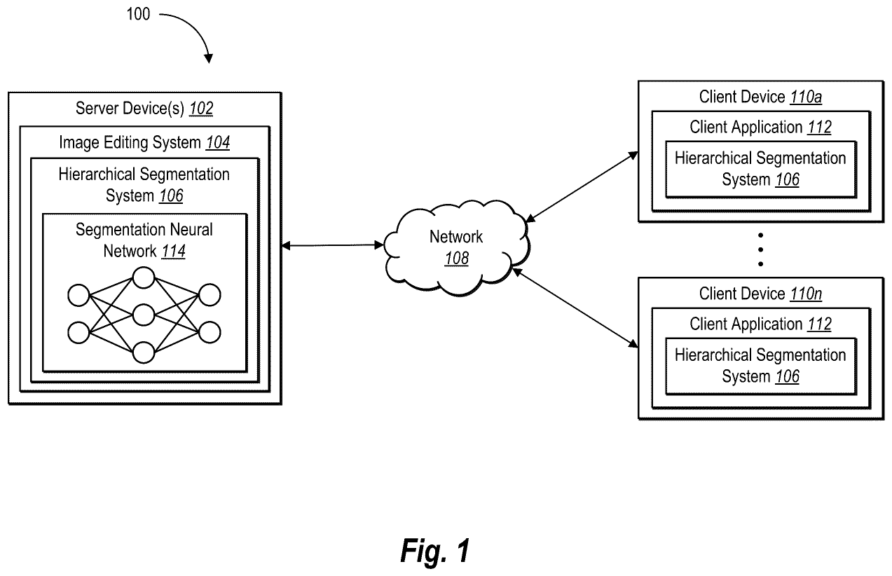

Additional detail regarding the hierarchical segmentation system will now be provided with reference to the figures. For example, FIG. 1 illustrates a schematic diagram of an exemplary system 100 in which a hierarchical segmentation system 106 operates. As illustrated in FIG. 1, the system 100 includes a server device(s) 102, a network 108, and client devices 110a-110n.

Although the system 100 of FIG. 1 is depicted as having a particular number of components, the system 100 is capable of having any number of additional or alternative components (e.g., any number of server devices, client devices, or other components in communication with the hierarchical segmentation system 106 via the network 108). Similarly, although FIG. 1 illustrates a particular arrangement of the server device(s) 102, the network 108, and the client devices 110a-110n, various additional arrangements are possible.

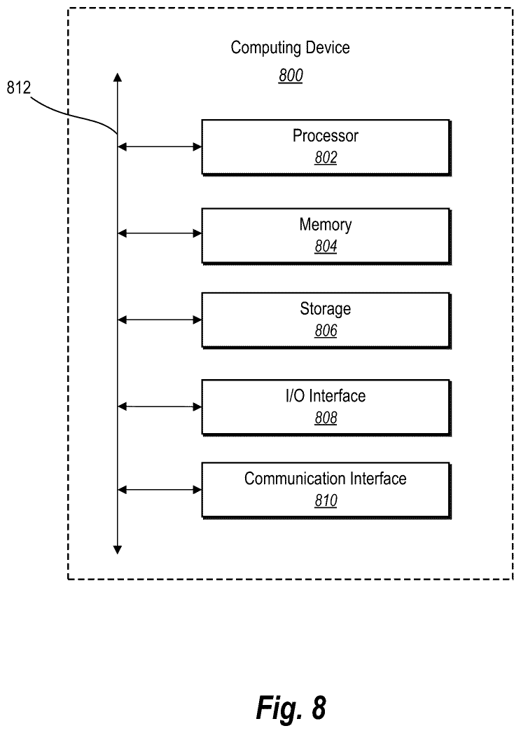

The server device(s) 102, the network 108, and the client devices 110a-110n are communicatively coupled with each other either directly or indirectly (e.g., through the network 108 discussed in greater detail below in relation to FIG. 8). Moreover, the server device(s) 102 and the client devices 110a-110n include one or more of a variety of computing devices (including one or more computing devices as discussed in greater detail with relation to FIG. 8).

As mentioned above, the system 100 includes the server device(s) 102. In one or more embodiments, the server device(s) 102 generates, stores, receives, and/or transmits data, including digital images and/or masks for objects portrayed in digital images. In one or more embodiments, the server device(s) 102 comprises one or more data server devices. In some implementations, the server device(s) 102 comprises one or more communication server devices or one or more web-hosting server devices.

In one or more embodiments, the image editing system 104 provides functionality by which a client device (e.g., a user of one of the client devices 110a-110n) generates, edits, manages, and/or stores digital images. For example, in some instances, a client device sends a digital image to the image editing system 104 hosted on the server device(s) 102 via the network 108. The image editing system 104 then provides many options that are usable by the client device to edit the digital image, store the digital image, and subsequently search for, access, and view the digital image. For instance, in some cases, the image editing system 104 provides one or more options that are usable by the client device to generate, view, and/or use masks generated for an object portrayed in a digital image.

In one or more embodiments, the client devices 110a-110n include computing devices that are capable of accessing, modifying, and/or storing digital images, including modified digital images and/or masks generated from objects portrayed therein. For example, in some embodiments, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that are capable of accessing, modifying, and/or storing digital images, including modified digital images and/or masks generated from objects portrayed therein. For example, in some embodiments, the client application 112 includes a software application installed on the client devices 110a-110n. Additionally, or alternatively, the client application 112 includes a web browser or other application that accesses a software application hosted on the server device(s) 102 (and supported by the image editing system 104).

To provide an example implementation, in some embodiments, the hierarchical segmentation system 106 on the server device(s) 102 supports the hierarchical segmentation system 106 on the client device 110n. For instance, in some cases, the hierarchical segmentation system 106 on the server device(s) 102 generates or learns parameters for the segmentation neural network 114. The hierarchical segmentation system 106 then, via the server device(s) 102, provides the segmentation neural network 114 to the client device 110n. In other words, the client device 110n obtains (e.g., downloads) the segmentation neural network 114 (e.g., with any learned parameters) from the server device(s) 102. Once downloaded, the hierarchical segmentation system 106 on the client device 110n uses the segmentation neural network 114 to generate a set of masks corresponding to different semantic levels for an object portrayed in a digital image independent from the server device(s) 102.

In alternative implementations, the hierarchical segmentation system 106 includes a web hosting application that allows the client device 110n to interact with content and services hosted on the server device(s) 102. To illustrate, in one or more implementations, the client device 110n accesses a software application supported by the server device(s) 102. The client device 110n provides input to the server device(s) 102, such as a digital image and user input selecting one or more pixels within an object portrayed in the digital image. In response, the hierarchical segmentation system 106 on the server device(s) 102 generates a set of masks corresponding to various semantic levels for the object. The server device(s) 102 then provides one or more of the masks to the client device 110n.

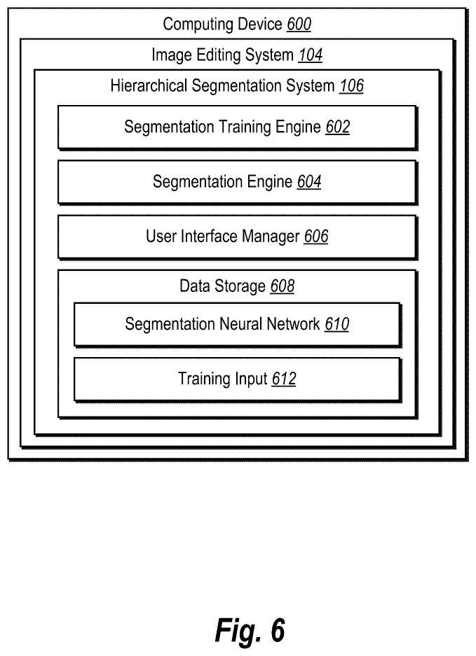

Indeed, the hierarchical segmentation system 106 is able to be implemented in whole, or in part, by the individual elements of the system 100. Indeed, although FIG. 1 illustrates the hierarchical segmentation system 106 being implemented with regard to the server device(s) 102, different components of the hierarchical segmentation system 106 are able to be implemented by a variety of devices within the system 100. For example, one or more (or all) components of the hierarchical segmentation system 106 are implemented by a different computing device (e.g., one of the client devices 110a-110n) or a separate server device from the server device(s) 102 hosting the image editing system 104. Indeed, as shown in FIG. 1, the client devices 110a-110n include the hierarchical segmentation system 106. Example components of the hierarchical segmentation system 106 will be described below with regard to FIG. 6.

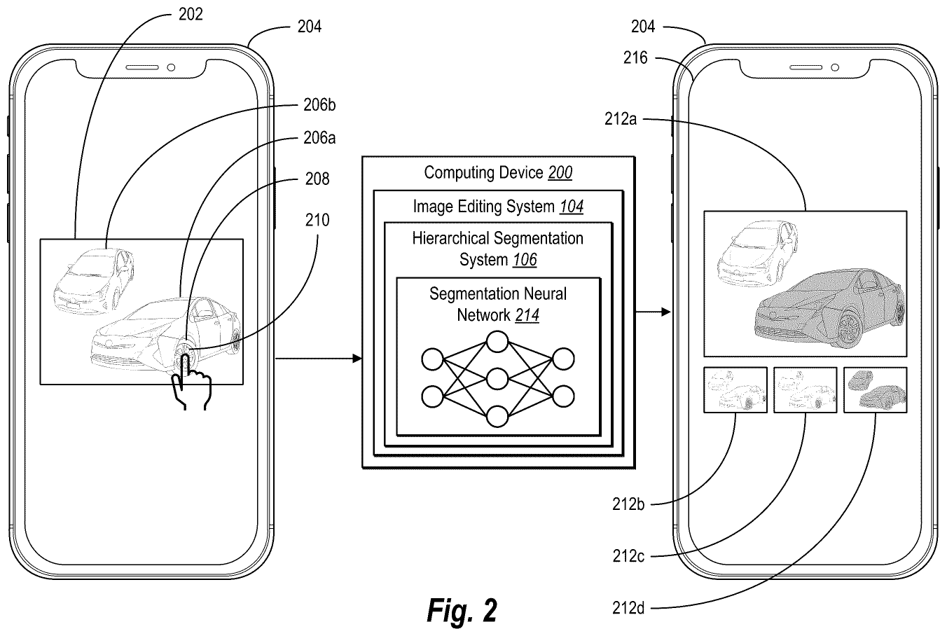

As mentioned, in one or more embodiments, the hierarchical segmentation system 106 generates a hierarchy of masks for an object within a digital image. In other words, the hierarchical segmentation system 106 generates a set of masks for the object where each mask corresponds to a different semantic level. FIG. 2 illustrates, the hierarchical segmentation system 106 generating a hierarchy of masks for an object portrayed in a digital image in accordance with one or more embodiments.

In one or more embodiments, an object includes a distinct visual element portrayed in a digital image. In particular, in some embodiments, an object includes a distinct visual element of a digital image that is identifiable separately from other visual elements portrayed in a digital image. In many instances, an object includes a group of pixels that, together, portray the distinct visual element separately from the portrayal of other pixels. Some examples of an object include a semantic area (e.g., the sky, the ground, water, etc.) or an instance of an identifiable thing (e.g., a person, an animal, a building, a car, or a food item).

In one or more embodiments, an object includes parts and/or subparts. In some embodiments, a part includes a visual element of a digital image that is a component of an object portrayed in the digital image, and a subpart includes a visual element of a digital image that is a component of a part (i.e., a sub-component of an object) portrayed in the digital image. In some cases, a part is semantically related to an object in that the object is formed from the part and one or more other parts within the digital image. Likewise, in certain instances, a subpart is semantically related to a part in that the part is formed from the subpart and one or more other subparts within the digital image. To provide an illustration, in some implementations, an object includes a person, a part of the object includes a hand of the person, and subparts of the part include the individual fingers of the hand.

In certain instances, a part is visually related to an object within a digital image even where the part is not semantically related to the object, and/or a subpart is visually related to a part within a digital image even where the subpart is not semantically related to the part. For instance, in some cases, a part of a person includes an item held by the person, and a subpart includes an item attached or otherwise connected to the item (e.g., the part includes an animal held by the person, and the subpart includes a food item in the mouth of the animal). In some instances, such parts and/or subparts are identifiable as separate objects. Thus, in various implementations, the hierarchical segmentation system identifies objects, parts, and subparts based on semantic relationships, visual relationships, or some combination thereof.

In some implementations, an object is part of an object group. In one or more embodiments, an object group includes a set of objects. In particular, in some cases, an object group includes a set of multiple related objects. For instance, in some cases, an object group includes a set of multiple objects that are related by object type (e.g., a set of automobiles) or object sub-type (e.g., a set of trucks). In some implementations, however, an object group includes a set of all objects portrayed in a digital image regardless of the type or sub-type of the object. Thus, an object group is defined at various levels in various implementations.

In one or more embodiments, a semantic level includes a conceptual level at which a visual element of a digital image is classified or identified or a conceptual level with which the visual element is otherwise associated. In particular, in some embodiments, a semantic level includes a conceptual level at which one or more pixels of a digital image are analyzed or processed. Indeed, in some embodiments, a pixel of a digital image is associated with a plurality of semantic levels—such as an object-level in that the pixel is associated with an object, a part-level in that the pixel is associated with a part of the object, a subpart in that the pixel is associated with a subpart of the part, and/or a group-level in that the pixel is associated with an object that is part of an object group portrayed in the digital image. Thus, in certain embodiments, the hierarchical segmentation system 106 analyzes or processes the pixel based on one or more of these semantic levels.

In some instances, the semantic levels associated with a pixel or group of pixels corresponds to a hierarchy of semantic levels in which one semantic level is considered higher or lower than an adjacent semantic level within the hierarchy. To illustrate, in some cases, a hierarchy of semantic levels associated with a pixel or group of pixels is as follows where each subsequent semantic level is hierarchically lower than the preceding semantic level: object group, object, part, and subpart. It should be noted, however, that alternative, fewer, or additional semantic levels are included in various implementations. For instance, in some cases, a subpart is composed of multiple sub-subparts, a sub-subpart is composed of multiple hierarchically lower components, and so forth. Likewise, in some implementations, an object group is part of a hierarchically higher semantic level that includes one or more other object groups.

As shown in FIG. 2, the hierarchical segmentation system 106 (operating on a computing device 200) receives a digital image 202 from a client device 204. Indeed, in some cases, the hierarchical segmentation system 106 receives the digital image 202 from a computing device (e.g., the client device 204) that is external to the computing device (e.g., the computing device 200) upon which the hierarchical segmentation system 106 operates. In some embodiments, however, the hierarchical segmentation system 106 receives the digital image 202 from another source within the computing device upon which the hierarchical segmentation system 106 operates. For instance, in some cases, the hierarchical segmentation system 106 retrieves or receives the digital image 202 from an internal storage of the computing device 200 or from another system operating on the computing device 200.

As illustrated in FIG. 2, the digital image 202 portrays a first object 206a and a second object 206b that are of the same object type (e.g., a car). Additionally, as illustrated, the first object 206a includes a plurality of parts, such as the part 208 (e.g., the wheel assembly of the car). As further shown the part 208 includes a plurality of subparts, such as the subpart 210 (the hub cap of the wheel assembly).

Additionally, as shown in FIG. 2, the hierarchical segmentation system 106 receives a user interaction with the digital image 202. In particular, the hierarchical segmentation system 106 receives a user selection of one or more pixels within the first object 206a. More specifically, the one or more pixels that are selected are positioned within the subpart 210 of the first object 206a.

As illustrated, in response to the user selection of the one or more pixels, the hierarchical segmentation system 106 generates a plurality of masks 212a-212d for the first object 206a. In one or more embodiments, a mask includes a map of a digital image or that has an indication for each pixel of whether the pixel corresponds to an object (or part or subpart or object group) or not. In some embodiments, the indication includes a binary indication (e.g., a “1” for pixels belonging to the object and a “0” for pixels not belonging to the object). In alternative implementations, the indication includes a probability (e.g., a number between 1 and 0) that indicates the likelihood that a pixel belongs to an object (or part or subpart or object group). To illustrate, in some cases, the closer the value is to 1, the more likely the pixel belongs to an object and vice versa.

In some implementations, the indication of a mask includes a number between 0 and 1 where the number represents the percentage of the light at the pixel that comes from an object. In some cases, either 0% (e.g., a value of 0) or 100% (e.g., a value of 1) of a pixel corresponds to an object as the pixel resides either entirely outside or entirely inside the object. In some instances, however, the color at a pixel is a blend between light coming from the object and light coming from the scene. For instance, in some embodiments, a pixel residing at the edge of an object or a pixel that is part of a very thin object (e.g., hair) includes light from both the object and the surrounding area. In certain cases, semi-transparent pixels include light from an object as well as light from another object or background positioned behind the object.

In particular, in response to the user selection of the one or more pixels, the hierarchical segmentation system 106 generates the plurality of masks 212a-212d at different semantic levels. Indeed, the plurality of masks 212a-212d includes a hierarchy of masks for the first object 206a. For instance, FIG. 2 illustrates the plurality of masks 212a-212d including an object-level mask 212a, a part-level mask 212b, a subpart-level mask 212c, and a group-level mask 212d.

As indicated in FIG. 2, the selected pixel(s) is associated with the semantic level of each mask. In particular, the selected pixel(s) is positioned within the visual element associated with the semantic level of each mask. To illustrate, the selected pixel(s) is positioned within the first object 206a (e.g., the car) corresponding to the object-level mask 212a, the part 208 (e.g., the wheel assembly of the car) corresponding to the part-level mask 212b, the subpart 210 (e.g., the hub cap of the wheel assembly) corresponding to the subpart-level mask 212c, and the object group that includes the first object 206a and the second object 206b and corresponds to the group-level mask 212d. Thus, the hierarchical segmentation system 106 generates the plurality of masks 212a-212d for the first object 206a by generating a mask for various visual elements associated with the selected pixel(s).

As illustrated, the hierarchical segmentation system 106 uses a segmentation neural network 214 to generate the plurality of masks 212a-212d. In one or more embodiments, a neural network includes a type of machine learning model, which can be tuned (e.g., trained) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

In one or more embodiments, a segmentation neural network includes a computer-implemented neural network that generates masks. In particular, in some embodiments, a segmentation neural network includes a neural network that generates one or more masks for an object portrayed in a digital image. To illustrate, in some cases, a segmentation neural network includes a neural network that analyzes a digital image portraying one or more objects and generates one or more masks based on the analysis. In some implementations, a segmentation neural network generates a hierarchy of masks for an object by generating a plurality of masks where each mask corresponds to a different semantic level.

As further illustrated by FIG. 2, the hierarchical segmentation system 106 provides the plurality of masks 212a-212d for display on the client device 204 (e.g., for display within a graphical user interface 216 of the client device 204). Indeed, in some cases, the hierarchical segmentation system 106 provides the plurality of masks 212a-212d for display on the same computing device from which the digital image 202 was received. In some cases, the hierarchical segmentation system 106 provides the plurality of masks 212a-212d for display on another computing device. As more specifically shown, the hierarchical segmentation system 106 provides the plurality of masks 212a-212d for display simultaneously. The hierarchical segmentation system 106 provides the plurality of masks 212a-212d for display in different configurations in different embodiments, as will be discussed in more detail below.

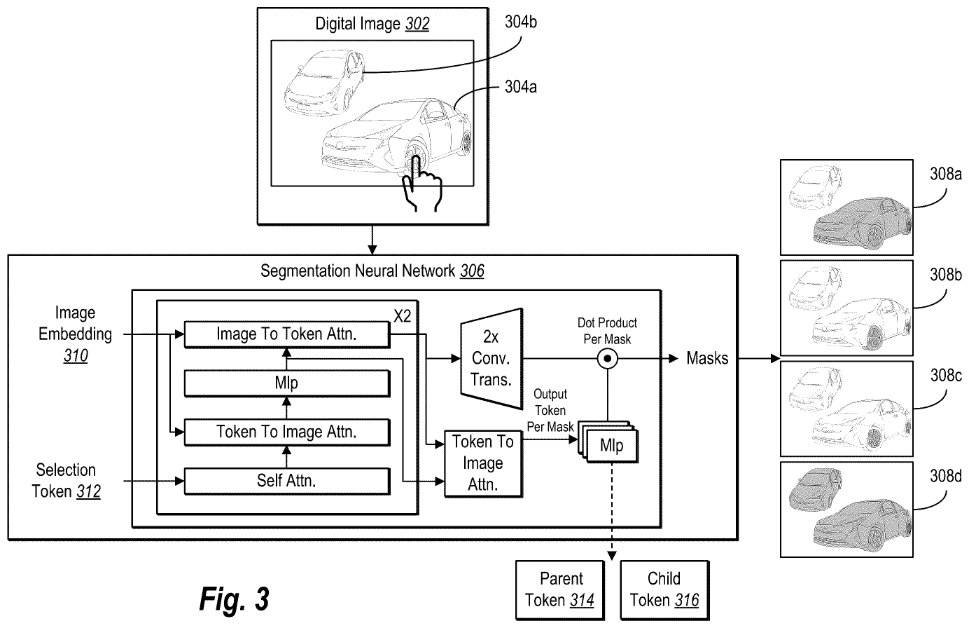

As just discussed, in one or more embodiments, the hierarchical segmentation system 106 uses a segmentation neural network to generate a hierarchy of masks in response to a user selection of one or more pixels within an object. In particular, the hierarchical segmentation system 106 uses the segmentation neural network to generate a plurality of masks at various semantic levels. FIG. 3 illustrates the hierarchical segmentation system 106 using a segmentation neural network to generate a plurality of masks at various semantic levels in accordance with one or more embodiments.

Indeed, as shown in FIG. 3, the hierarchical segmentation system 106 uses a segmentation neural network 306 to generate masks 308a-308d from a digital image 302 portraying a first object 304a and a second object 304b. In particular, the hierarchical segmentation system 106 uses the segmentation neural network 306 to generate the masks 308a-308d in accordance with a user selection of one or more pixels within the first object 304a. Indeed, the hierarchical segmentation system 106 generates an object-level mask 308a, a part-level mask 308b, a subpart-level mask 308c, and a group-level mask 308d.

As shown in FIG. 3, the hierarchical segmentation system 106 generates an image embedding 310 from the digital image 302. For example, in some embodiments, the hierarchical segmentation system 106 uses a trained image encoder to generate the image embedding 310 within a learned embedding space. The hierarchical segmentation system 106 provides the image embedding 310 as input to the segmentation neural network 306.

Additionally, the hierarchical segmentation system 106 generates or determines a selection token 312 from the user selection of the one or more pixels within the first object 304a. In some cases, the hierarchical segmentation system 106 generates or determines the selection token 312 to represent the selected pixel(s) (e.g., the RGB information of the selected pixel(s) or coordinates of the selected pixel(s) within the digital image 302). For instance, in some embodiments, the hierarchical segmentation system 106 assigns each position within the digital image 302 a token value and determines the selection token 312 based on the location the selected pixel(s) and the corresponding token value. In some instances, the selection token 312 includes an encoding, and the hierarchical segmentation system 106 generates the selection token 312 using an encoder. The hierarchical segmentation system 106 provides the selection token 312 as input to the segmentation neural network 306.

As illustrated, the segmentation neural network 306 includes various components for processing the input and generating the masks 308a-308d. For instance, FIG. 3 illustrates the segmentation neural network 306 including various attention layers, multi-layer perceptron (MLP) layers, and convolutional transformers. Further, the segmentation neural network 306 employs additional operations, such as one or more dot product operations. It should be understood, however, that the architecture of the segmentation neural network 306 shown in FIG. 3 is exemplary. The hierarchical segmentation system 106 uses various network architectures for the segmentation neural network 306 in various implementations.

As further shown in FIG. 3, the hierarchical segmentation system 106 uses the segmentation neural network 306 to generate and implement internal representations in generating the masks 308a-308d. In particular, the hierarchical segmentation system 106 uses the segmentation neural network 306 to generate and implement a parent token 314 and a child token 316 in generating the masks 308a-308d.

In one or more embodiments, a parent token includes a token having a parent relationship with another token. In particular, in some embodiments, a parent token includes a set of values that is generated internally within a neural network and has a parent relationship with another set of values. For instance, in some cases, a parent token includes a feature vector, feature map, or other set of internal values that has or indicates a parent relationship with an additional feature vector, feature map, or other set of internal values. In one or more embodiments, the parent relationship of the parent token with the other token corresponds to the parent token being hierarchically higher than the other token. In other words, the parent token includes values corresponding to a semantic level that is hierarchically higher than the values of the other token. In some implementations, a parent token includes a representation of a mask generated for an object portrayed within a digital image. Thus, in some cases, a parent token represents a mask of the object at a particular semantic level within a semantic hierarchy of masks.

Similarly, in one or more embodiments, a child token includes a token having a child relationship with another token. In particular, in some embodiments, a child token includes a set of values that is generated internally within a neural network and has a child relationship with another set of values. For instance, in some cases, a child token includes a feature vector, feature map, or other set of internal values that has or indicates a child relationship with an additional feature vector, feature map, or other set of internal values. In one or more embodiments, the child relationship of the child token with the other token corresponds to the child token being hierarchically lower than the other token. In other words, the child token includes values corresponding to a semantic level that is hierarchically lower than the values of the other token. In some implementations, a child token includes a representation of a mask generated for an object portrayed within a digital image. Thus, in some cases, a child token represents a mask of the object at a particular semantic level within a semantic hierarchy of masks.

While FIG. 3 illustrates the segmentation neural network 306 generating one parent token and one child token, the segmentation neural network 306 generates one or more additional tokens in generating the masks 308a-308d in various implementations. Further, while FIG. 3 illustrates generating tokens having a single relationship (e.g., a parent relationship or a child relationship), the segmentation neural network 306 generates tokens having multiple relationships (e.g., a parent relationship and a child relationship) in some embodiments. In particular, in certain implementations, the segmentation neural network 306 generates a token having multiple relationships with multiple tokens. For example, in some cases, the segmentation neural network 306 generates a token that has a parent relationship with a first token (i.e., the token is a parent token with respect to the first token) and a child relationship with a second token (i.e., the token is a child token with respect to the second token). In some implementations, however, the segmentation neural network 306 generates separate parent and child tokens.

Additionally, in one or more embodiments, the hierarchical segmentation system 106 uses the segmentation neural network 306 to generate the tokens to correspond to various semantic levels. For example, in some cases, the segmentation neural network 306 generates a token corresponding to each semantic level for which a mask is to be generated. Thus, in some embodiments, the hierarchical segmentation system 106 uses the segmentation neural network 306 to generate a plurality of tokens that-through their various relationships-indicate an associated semantic hierarchy. In other words, in some cases, the relationships of the tokens indicate which token is hierarchically higher or lower than another token.

To illustrate, in one or more embodiments, the hierarchical segmentation system 106 uses the segmentation neural network 306 to generate a plurality of tokens-a first token corresponding to a first semantic level (e.g., an object-level token), a second token corresponding to a second semantic level (e.g., a part-level token), a third token corresponding to a third semantic level (e.g., a subpart-level token), and a fourth token corresponding to a fourth semantic level (e.g., a group-level token). In some instances, the semantic level corresponding to a given token is hierarchically higher or hierarchically lower than an adjacent semantic level. In other words, the given token is a parent token or a child token with respect to the token corresponding to an adjacent semantic level.

Further, as indicated in FIG. 3, the hierarchical segmentation system 106 uses the segmentation neural network 306 to generate the masks 308a-308d from the tokens. In particular, in some embodiments, the hierarchical segmentation system 106 uses the segmentation neural network 306 to generate a mask from each token. To illustrate, in some implementations, the segmentation neural network 306 generates a first mask (e.g., an object-level mask) from a first token corresponding to a first semantic level, a second mask (e.g., a part-level mask) from a second token corresponding to a second semantic level, a third mask (e.g., a subpart-level mask) from a third token corresponding to a third semantic level, and a fourth mask (e.g., a group-level mask) from a fourth token corresponding to a fourth semantic level. Thus, in some cases, the segmentation neural network 306 uses the tokens (i.e., the parent and child tokens) to generate a hierarchy of masks.

In one or more embodiments, the hierarchical segmentation system 106 uses a semantic hierarchy in which object group is the highest semantic level, followed by object, part, and subpart. Other hierarchies are used in other implementations, and the hierarchical segmentation system 106 uses additional, fewer, and/or alternative semantic levels in various cases.

By generating a plurality of masks based on tokens having parent-child relationships, the hierarchical segmentation system 106 operates with improved flexibility when compared to conventional systems. In particular, by generating tokens having parent-child relationships and to further generate masks based on those tokens, the hierarchical segmentation system 106 enables the segmentation neural network to perform the segmentation aware of the semantic relationships among the different visual elements associated with selected pixels. Indeed, the hierarchical segmentation system 106 enables the segmentation neural network to flexibly target the semantic hierarchy of an object (e.g., the selected pixels within the object) portrayed in an image.

Indeed, as previously mentioned, while some conventional systems generate masks that may be part of a semantic hierarchy, such systems typically do not target such results. In particular, such systems often fail to generate masks for particular semantic levels. Rather, they tend to generate arbitrary masks that includes, in some instances, duplicates or garbage results. By contrast, the hierarchical segmentation system 106 flexibly generates masks corresponding to designated semantic levels by targeting those semantic levels via the segmentation neural network.

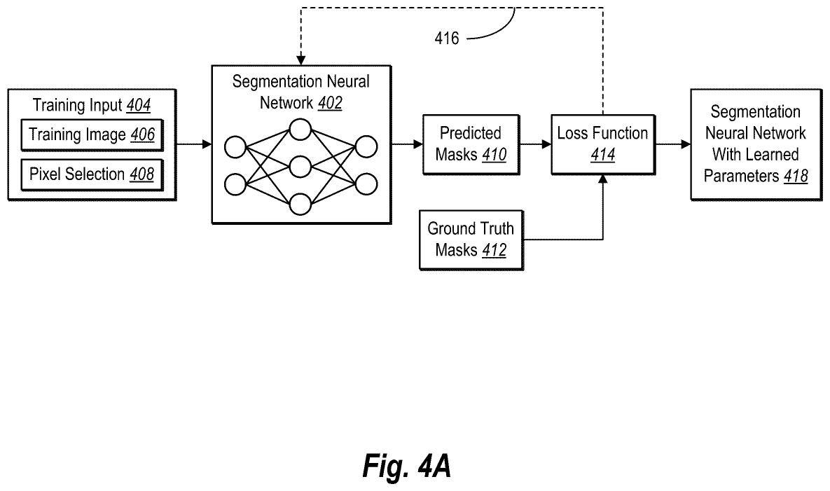

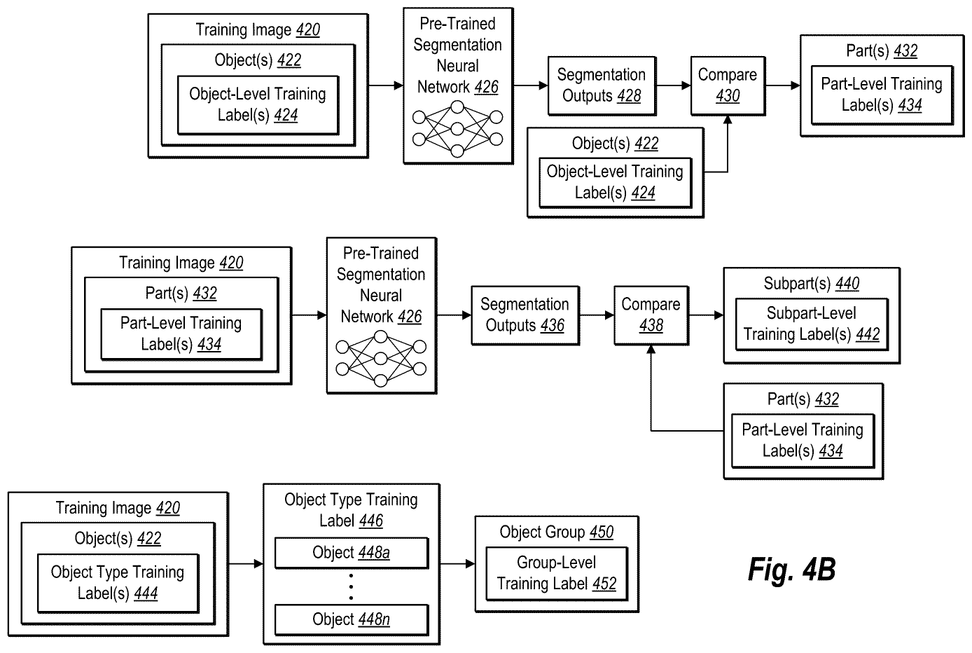

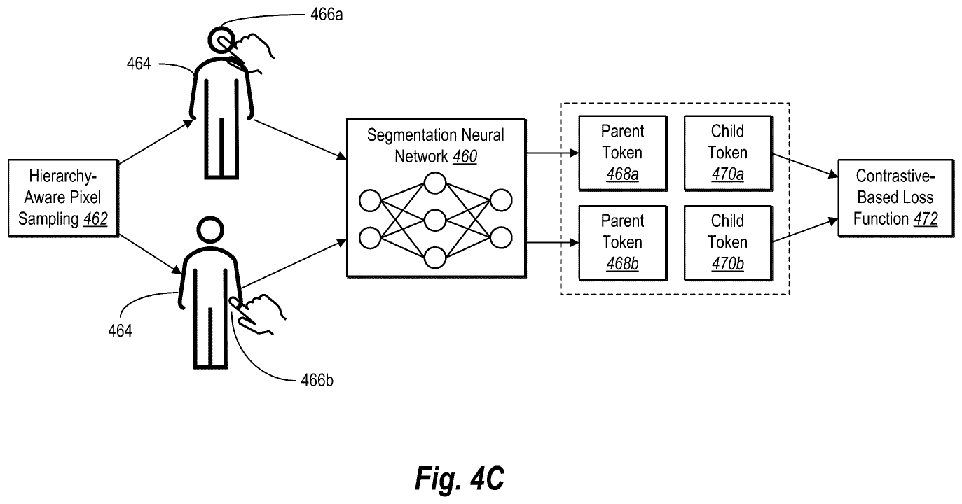

As previously mentioned, in one or more embodiments, the hierarchical segmentation system 106 trains a segmentation neural network to generate a hierarchy of masks from a digital image in response to a user selection of one or more pixels of an object portrayed therein. In particular, in some cases, the hierarchical segmentation system 106 generates, optimizes, learns, or otherwise determines parameters for the segmentation neural network via a training process. FIGS. 4A-4C illustrate the hierarchical segmentation system 106 training a segmentation neural network to generate a hierarchy of masks for an object portrayed in a digital image in accordance with one or more embodiments.

For instance, FIG. 4A illustrates the hierarchical segmentation system 106 determining parameters for a segmentation neural network 402 to generate a hierarchy of masks for an object portrayed in a digital image in accordance with one or more embodiments. As shown in FIG. 4A, the hierarchical segmentation system 106 provides training input 404 to the segmentation neural network 402. As further shown, the training input 404 includes a training image 406 and a pixel selection 408. In some embodiments, the training image 406 includes a digital image portraying one or more objects. In some instances, at least one object portrayed in the training image 406 includes parts or subparts. In some cases, at least two objects form an object group. Additionally, in certain cases, the pixel selection 408 includes a selection of one or more pixels within the training image 406 (e.g., within an object portrayed in the digital image).

As illustrated, the hierarchical segmentation system 106 uses the segmentation neural network 402 to generate predicted masks 410 from the training input 404. In particular, the segmentation neural network 402 generates the predicted masks 410 for the object associated with the pixel selection 408. In one or more embodiments, the predicted masks 410 include various predicted mask corresponding to various semantic levels. For instance, in some cases, the predicted masks 410 include a predicted object-level mask, a predicted part-level mask, a predicted subpart-level mask, and a predicted group-level mask.

As further illustrated, the hierarchical segmentation system 106 compares the predicted masks 410 to ground truth masks 412 via a loss function 414. In one or more embodiments, the ground truth masks 412 include annotated masks corresponding to the training image 406. For example, in some cases, the ground truth masks 412 include masks with associated training labels that indicate the semantic level of each mask. For instance, in some cases, the ground truth masks 412 include a first ground truth mask and an associated object-level training label, a second ground truth mask and an associated part-level training label, a third ground truth mask and an associated subpart-level training label, and a fourth ground truth mask and an associated group-level training label. Thus, the hierarchical segmentation system 106 uses the loss function 414 to determine an error (e.g., a loss) of the segmentation neural network 402 in generating the predicted masks 410.

As shown in FIG. 4A, the hierarchical segmentation system 106 modifies parameters of the segmentation neural network 402 based on comparing the predicted masks 410 to the ground truth masks 412 (as shown by the dashed arrow 416). For instance, in some cases, the hierarchical segmentation system 106 back propagates the determined error to modify the parameters accordingly. In particular, in some instances, the hierarchical segmentation system 106 modifies the parameters to reduce the error of the segmentation neural network 402 in generating mask predictions.

Though FIG. 4A illustrates a single training iteration in which the parameters of segmentation neural network 402 are modified, the hierarchical segmentation system 106 modifies the parameters over multiple iterations in some implementations. Indeed, in some cases, the hierarchical segmentation system 106 performs several iterations of using the segmentation neural network 402 to predict masks from training input, comparing the predictions to corresponding ground truths, and updating the parameters of the segmentation neural network 402 based on the comparison. Thus, over several iterations, the hierarchical segmentation system 106 generates the segmentation neural network 418 with learned parameters (e.g., optimized parameters).

In some embodiments, the hierarchical segmentation system 106 generates training data to use in determining parameters that enable a segmentation neural network to generate a plurality of masks of different semantic levels for an object portrayed in a digital image. Indeed, in some cases, the amount of available training data is insufficient and obtaining additional training data is prohibitive. For instance, employing humans to label training images is often costly and time-consuming. Thus, in some instances, the hierarchical segmentation system 106 generates additional training data to supplement the available training data. FIG. 4B illustrates the hierarchical segmentation system 106 generating training data for use in determining parameters for a segmentation neural network in accordance with one or more embodiments.

As indicated by FIG. 4B, in certain implementations, the hierarchical segmentation system 106 begins generating training data by obtaining a dataset of labeled objects. In some instances, the dataset includes a set of training images where each training image portrays one or more objects therein. Further, the dataset includes object-level training labels that label the objects portrayed therein. Indeed, in some cases, training data having labeled objects is more readily available than training data having labeled visual components corresponding to other semantic levels (e.g., parts, subparts, and/or object groups) due to prior efforts focusing on objects at the object level. Thus, in some embodiments, the hierarchical segmentation system 106 generates training data for other semantic levels using a dataset of labeled objects.

For instance, as shown in FIG. 4B, the hierarchical segmentation system 106 obtains a training image 420 from a dataset of labeled objects. As shown, the training image 420 includes one or more objects 422 that are associated with one or more object-level training labels 424. In other words, the training image 420 portrays one or more objects, which are each annotated with an object-level training label that identifies the object. In some cases, each object-level training label generally identifies the corresponding object as an object or more specifically indicates the object type. In some cases, each object-level training label indicates the boundaries of the corresponding object. For instance, in some cases, each object-level training label includes an object-level mask with an associated indication that the mask corresponds to an object (or a particular object type).

As illustrated in FIG. 4B, the hierarchical segmentation system 106 uses a pre-trained segmentation neural network 426 to generate segmentation outputs 428 from the training image 420. In one or more embodiments, a segmentation output includes a neural network output that indicates a segmentation of a digital image, such as a training image. In particular, in some embodiments, a segmentation output includes a neural network output indicating a segment extracted or otherwise identified from a digital image. For instance, in some cases, a segmentation output includes a mask corresponding to an identified segment. As another example, in some embodiments, a segmentation output includes a cutout of the segment from the digital image or a copy of the digital image with the relevant segment highlighted or outlined.

The pre-trained segmentation neural network 426 includes a segmentation neural network of various neural network architectures in various implementations. For instance, in some cases, the architecture of the pre-trained segmentation neural network 426 is similar to the architecture of the segmentation neural network to be trained using the training data. In some cases, the pre-trained segmentation neural network 426 is trained to generate one or more segmentation outputs from a digital image. In some instances, however, the pre-trained segmentation neural network 426 is not trained to target a hierarchy of segmentation outputs (e.g., a hierarchy of masks). In other words, the pre-trained segmentation neural network 426 is not trained to target generating segmentation outputs for designated semantic levels.

Indeed, as indicated by FIG. 4B, in one or more embodiments, the segmentation outputs 428 include a plurality of segmentation outputs. Further, in some embodiments, the segmentation outputs 428 correspond to a variety of semantic levels.

As illustrated in FIG. 4B, the hierarchical segmentation system 106 performs an act 430 of comparing the segmentation outputs 428 to the one or more objects 422 from the training image 420. For instance, in some cases, the hierarchical segmentation system 106 compares each segmentation output generated by the pre-trained segmentation neural network 426 to each object portrayed in the training image 420. As shown, based on the comparison, the hierarchical segmentation system 106 identifies one or more parts 432 for the training image 420. Further, the hierarchical segmentation system 106 determines or generates one or more part-level training labels 434 for the one or more parts 432. In particular, the hierarchical segmentation system 106 determines or generates a part-level training label for each identified part.

To illustrate, in one or more embodiments, the hierarchical segmentation system 106 compares an object to a segmentation output to determine whether the object contains the segmentation output. In other words, the hierarchical segmentation system 106 determines whether the segment corresponding to the segmentation output is positioned within the boundaries of the object within the training image 420. Upon determining that the object does contain the segmentation output, the hierarchical segmentation system 106 identifies the segment of the training image 420 corresponding to the segmentation output as a part of the object. Further, the hierarchical segmentation system 106 generates a part-level training label for the part.

In one or more embodiments, the hierarchical segmentation system 106 only determines the segmentation output to be a part of an object if the segmentation output does not contain the object in its entirety. In particular, the hierarchical segmentation system 106 determines that the segment corresponding to the segmentation output is a part of an object upon determining that the segment includes only a portion of the object that is less than the entire object. Thus, the hierarchical segmentation system 106 differentiates between segmentation outputs corresponding to whole objects and segmentation outputs corresponding to parts of objects.

Thus, upon identifying one or more parts within the training images and generating one or more corresponding part-level training labels, the hierarchical segmentation system 106 modifies the dataset of labeled objects to include the labeled parts. In one or more embodiments, the hierarchical segmentation system 106 further supplements the dataset with hand-labeled parts. Indeed, in certain implementations, the hierarchical segmentation system 106 incorporates hand-labeled training data where available.

As indicated by FIG. 4B, the hierarchical segmentation system 106 further generates the training data by identifying subparts within the dataset. In particular, the hierarchical segmentation system 106 identifies subparts portrayed within the training images of the dataset. Indeed, as shown, the hierarchical segmentation system 106 provides the training image 420 portraying the one or more parts 432 associated with the one or more part-level training labels 434 (previously determined) to the pre-trained segmentation neural network 426. The hierarchical segmentation system 106 uses the pre-trained segmentation neural network 426 to generate segmentation outputs 436.

The hierarchical segmentation system 106 performs an act 438 of comparing the segmentation outputs 436 to the one or more parts 432 from the training image 420. For instance, in some cases, the hierarchical segmentation system 106 compares each segmentation output generated to each part identified in the training image 420 (e.g., to determine whether the part contains the segmentation output). As shown, based on the comparison, the hierarchical segmentation system 106 identifies one or more subparts 440 for the training image 420. Further, the hierarchical segmentation system 106 determines or generates one or more subpart-level training labels 442 for the one or more subparts 440. In particular, the hierarchical segmentation system 106 determines or generates a subpart-level training label for each identified subpart.

Though FIG. 4B illustrates the hierarchical segmentation system 106 using separate sets of segmentation outputs for identifying the part(s) and subpart(s) of the training image 420, the hierarchical segmentation system 106 uses the same set of segmentation outputs in some embodiments. Indeed, in some cases, the hierarchical segmentation system 106 uses the pre-trained segmentation neural network 426 to generate a single set of segmentation outputs from the training image 420. The hierarchical segmentation system 106 compares the segmentation outputs to the objects portrayed in the training image 420 to identify and label parts of those objects. The hierarchical segmentation system 106 further compares the segmentation outputs to the identified parts to identify and label subparts. Thus, in some instances, the hierarchical segmentation system 106 labels a segment as a part upon determining that its corresponding segmentation output is contained within an object but subsequently modifies the label to indicate the segment is a subpart upon determining that the segmentation output is contained within another segment labeled as a part of the object.

Thus, upon identifying one or more subparts within the training images and generating one or more corresponding subpart-level training labels, the hierarchical segmentation system 106 modifies the dataset of labeled objects to include the labeled subparts. In one or more embodiments, the hierarchical segmentation system 106 further supplements the dataset with hand-labeled subparts.

Additionally, as indicated by FIG. 4B, the hierarchical segmentation system 106 further generates the training data by identifying object groups within the dataset. In particular, the hierarchical segmentation system 106 identifies object groups portrayed within the training images of the dataset. Indeed, as shown, the training image 420 includes the one or more objects 422. As further shown, the one or more objects 422 are associated with one or more object type training labels 444. Indeed, as previously mentioned, the object-level training label associated with an object indicates the type of object in some instances. Thus, in some cases, the one or more object-level training labels 424 discussed above include the one or more object type training labels 444. In certain implementations, however, the one or more object-level training labels 424 and the one or more object type training labels 444 are separate sets of training labels.

As indicated in FIG. 4B, the hierarchical segmentation system 106 determines whether the same object type training label is associate with multiple objects portrayed in the training image 420. Indeed, as shown, the hierarchical segmentation system 106 determines that the object type training label 446 is associated with objects 448a-448n, indicating that the objects 448a-448n are all of the same type. Upon determining that the objects 448a-448n are associated with the object type training label 446, the hierarchical segmentation system 106 determines that the training image 420 includes an object group 450 that includes the objects 448a-448n. The hierarchical segmentation system 106 further generates a group-level training label 452 for the object group 450. In particular, in some instances, the hierarchical segmentation system 106 generates a group-level training label for each of the objects 448a-448n included in the object group 450.

Thus, upon identifying one or more object groups within the training images and generating one or more corresponding group-level training labels, the hierarchical segmentation system 106 modifies the dataset of labeled objects to include the labeled object groups. In one or more embodiments, the hierarchical segmentation system 106 further supplements the dataset with hand-labeled object groups. As such, the hierarchical segmentation system 106 generates the training data by generating a dataset of labeled objects, labeled parts, labeled subparts, and labeled object groups. In one or more embodiments, the hierarchical segmentation system 106 uses the dataset as described above with reference to FIG. 4A to train a segmentation neural network to generate a hierarchy of masks in response to a user selection of one or more pixels within an object portrayed in a digital image.

In some embodiments, the hierarchical segmentation system 106 trains a segmentation neural network to generate hierarchies of masks by distributing training input sufficiently among the visual elements of a digital image. Further, in some instances, the hierarchical segmentation system 106 trains a segmentation neural network using a contrastive-based loss. FIG. 4C illustrates the hierarchical segmentation system 106 training a segmentation neural network using distributed training input and a contrastive-based loss in accordance with one or more embodiments.

As shown in FIG. 4C, the hierarchical segmentation system 106 provides training input to a segmentation neural network 460 via hierarchy-aware pixel sampling 462. In particular, the hierarchical segmentation system 106 provides training input that includes pixel selections covering the various visual elements (e.g., object, part, subpart, and/or object group) of a training image. Indeed, as mentioned above with reference to FIG. 4A, the hierarchical segmentation system 106 uses training input that includes a training image and a pixel selection having a selection of one or more pixels of the training image. In some implementations, the hierarchical segmentation system 106 uses the same training image through several training iterations. In other words, the hierarchical segmentation system 106 uses the same training image to provide multiple training inputs to the segmentation neural network 460. Thus, in certain cases, the hierarchical segmentation system 106 uses the hierarchy-aware pixel sampling 462 to ensure that multiple visual elements of the training image are represented throughout training.

Indeed, in many conventional systems, certain visual elements of training images are significantly underrepresented within the training data due to the approach taken in sampling from the training images. For instance, some conventional systems use a random sampling. The visual elements of an image, however, often vary in size. Indeed, in many cases, even the different parts of the same object (or different subparts of the same part) vary in size with some parts (or subparts) being significantly larger than other parts (or subparts). Thus, a random sampling approach often fails to expose the segmentation neural network to different parts of the same object (or different subparts of the same part). As a result, the segmentation neural network often fails to properly distinguish between these different visual elements.

As shown in FIG. 4C, the hierarchical segmentation system 106 uses the hierarchy-aware pixel sampling 462 to target various parts of an object 464 (e.g., a person) in the training input. Though not explicitly shown, the object 464 represents an object portrayed in a digital image, such as a training image to be used in training the segmentation neural network 460. In particular, the hierarchical segmentation system 106 determines a first pixel selection of a first part 466a (e.g., the head) of the object 464 and determines a second pixel selection of a second part 466b (e.g., an arm) of the object 464.

In one or more embodiments, the hierarchical segmentation system 106 provides the pixel selections as part of separate training inputs to segmentation neural network 460. For instance, in some cases, the hierarchical segmentation system 106 provides the first pixel selection of the first part 466a as part of a first training input (e.g., with the digital image portraying the object 464). Further, the hierarchical segmentation system 106 provides the second pixel selection of the second part 466b as part of a second training input (e.g., with the digital image portraying the object 464).

As shown, the hierarchical segmentation system 106 uses the segmentation neural network 460 to generate tokens from the training input. In particular, the hierarchical segmentation system 106 uses the segmentation neural network 460 to generate internal representations (i.e., tokens) that are further used in generating predicted masks corresponding to the training input. For instance, as shown, the hierarchical segmentation system 106 generates a first parent token 468a and a first child token 470a from the first training input that includes the first pixel selection of the first part 466a. Further, the hierarchical segmentation system 106 generates a second parent token 468b and a second child token 470b from the second training input that includes the second pixel selection of the second part 466b.

In one or more embodiments, the parent and child portions correspond to different visual elements associated with the respective pixel selections. For instance, in some cases, the first parent token 468a corresponds to the object 464 and the first child token 470a corresponds to the first part 466a. Similarly, the second parent token 468b corresponds to the object 464 and the second child token 470b corresponds to the second part 466b. Thus, as previously mentioned, the tokens generated by the segmentation neural network 460 represent the parent-child relationships between various visual elements of a digital image in some implementations.

As further shown in FIG. 4C, the hierarchical segmentation system 106 uses a contrastive-based loss function 472 to compare the tokens generated by the segmentation neural network 460. In one or more embodiments, the hierarchical segmentation system 106 uses the contrastive-based loss function 472 as defined below.

$$max ( s i m ( P {T}_{1} , {PT}_{2} ) - s i m ( C {T}_{1} , {CT}_{2} ) + μ , 0 ) \qquad ( 1 )$$

In equation 1, PT₁ represents the first parent token 468a and PT₂ represents the second parent token 468b. Additionally, CT₁ represents the first child token 470a and CT₂ represents the second child token 470b. Further, u represents a regularization term, weight, or a hyperparameter. Equation 1 is maximized when the first term in the parenthesis is similar and the second term is dissimilar. Thus, in some embodiments, the hierarchical segmentation system 106 uses the contrastive-based loss function 472 represented by equation 1 to enable the segmentation neural network 460 to learn to generate similar tokens corresponding to an object of a digital image regardless of which part of the object is selected and to learn to generate different tokens representing different parts of the same object. Similarly, in some cases, the hierarchical segmentation system 106 uses the contrastive-based loss function 472 to enable the segmentation neural network 460 to learn to generate similar tokens corresponding to a part of an object regardless of which subpart is selected and to learn to generate different tokens representing different subparts of the same part.

In various embodiments, the hierarchical segmentation system 106 similarly uses the contrastive-based loss function 472 for various other visual elements that are part of a semantic hierarchy. Thus, in general, the hierarchical segmentation system 106 uses the contrastive-based loss function 472 to learn to generate similar tokens corresponding to the same visual element of a particular semantic level and to generate different tokens corresponding to different visual elements of a lower semantic level.

In one or more embodiments, the hierarchical segmentation system 106 determines a loss via the contrastive-based loss function 472 and uses the determined loss to modify parameters of the segmentation neural network 460. For instance, in some cases, the hierarchical segmentation system 106 back propagates the determined loss to update the parameters.

As indicated in FIG. 4C, in one or more embodiments, the hierarchical segmentation system 106 uses pairs of training inputs to implement the contrastive-based loss function 472. Indeed, in some cases, the hierarchical segmentation system 106 uses pairs of training inputs that include the same digital image but different pixel selections to train the segmentation neural network 460 via the contrastive-based loss function 472.

In one or more embodiments, the hierarchical segmentation system 106 uses the sampling approach and/or the contrastive-based loss function 472 described with reference to FIG. 4C along with the training approach described with reference to FIG. 4A. Thus, in some cases, the hierarchical segmentation system 106 uses multiple losses where at least a first loss is determined by comparing predicted masks to ground truth masks and at least a second loss is determined by comparing tokens via the contrastive-based loss function 472. To illustrate, in some cases, the hierarchical segmentation system 106 implements at least the first loss in every training iteration and implements at least the second loss in every other training iteration (as at least two iterations are needed to compare the respective tokens).

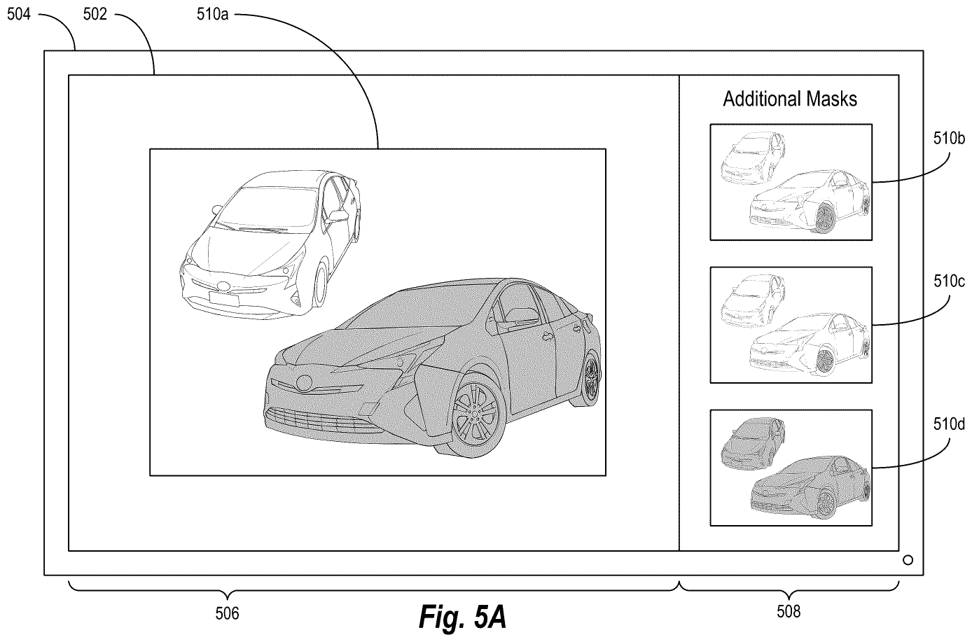

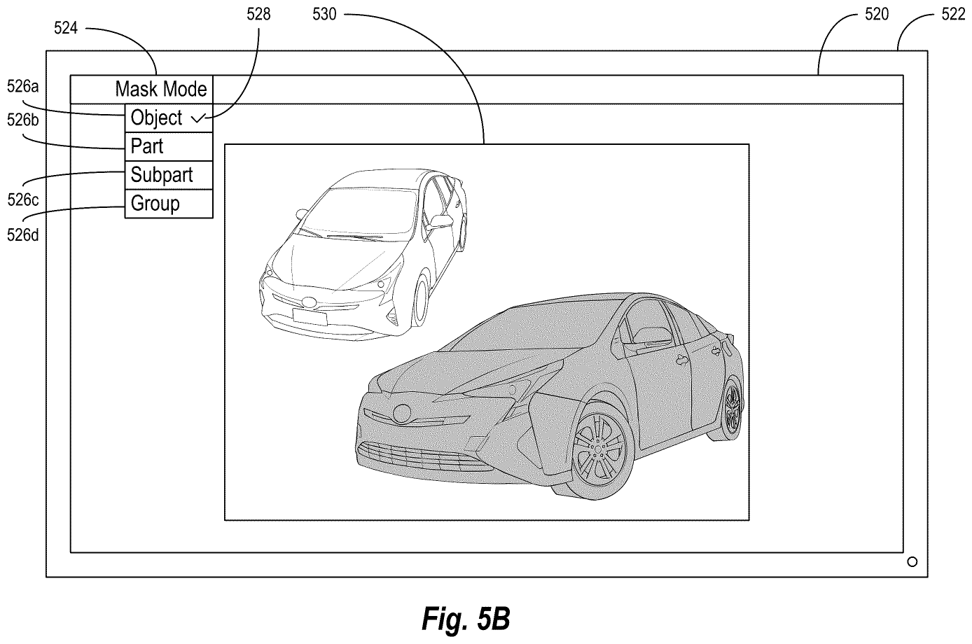

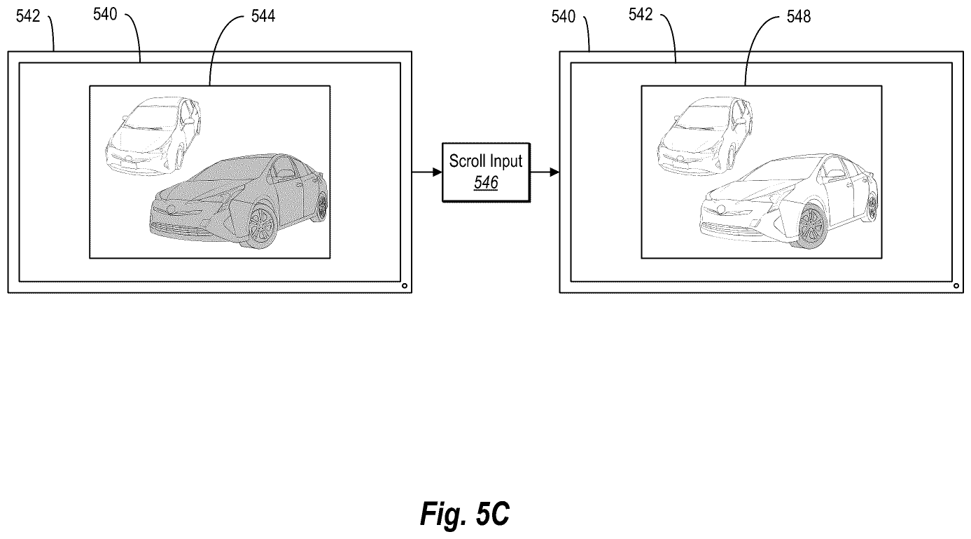

As previously mentioned, various embodiments of the hierarchical segmentation system 106 present the hierarchy of masks generated from a digital image via various graphical user interface configurations. FIGS. 5A-5C illustrate graphical user interface configurations used by the hierarchical segmentation system 106 to present a hierarchy of masks in accordance with one or more embodiments.

For instance, FIG. 5A illustrates a graphical user interface used by the hierarchical segmentation system 106 to provide all generated masks for simultaneous display in accordance with one or more embodiments. In particular, FIG. 5A illustrates a graphical user interface 502 displayed on a client device 504. As illustrated, the hierarchical segmentation system 106 provides an editing window 506 and a viewing window 508 within the graphical user interface 502. Within the editing window 506, the hierarchical segmentation system 106 provides a first mask 510a for display. Additionally, within the viewing window 508, the hierarchical segmentation system 106 provides a second mask 510b, a third mask 510c, and a fourth mask 510d for display. Though FIG. 5A illustrates masks corresponding to particular semantic levels provided within the editing window 506 and the viewing window 508, other configurations are used in other embodiments.

In some cases, the hierarchical segmentation system 106 provides the editing window 506 for modifying the corresponding digital image. For instance, in some cases, the hierarchical segmentation system 106 provides the first mask 510a for display within the editing window 506 to indicate that the first mask 510a is active. In other words, the hierarchical segmentation system 106 provides the first mask 510a to indicate that the first mask 510a is currently usable for editing the digital image (e.g., modifying the visual element corresponding to the first mask 510a). In some cases, the hierarchical segmentation system 106 changes the mask displayed in the editing window 506 in response to a user selection of one of the masks displayed in the viewing window 508. For instance, upon detecting a user selection of the second mask 510b, the hierarchical segmentation system 106 modifies the editing window 506 to display the second mask 510b and updates the viewing window 508 to display the first mask 510a.

In some cases, the hierarchical segmentation system 106 provides all generated masks for simultaneous display in another configuration. For instance, in some cases, the hierarchical segmentation system 106 overlays all masks over one another within the graphical user interface 502. In some embodiments, the hierarchical segmentation system 106 colors the masks differently to provide a visual distinction among the various semantic levels. For instance, in some implementations, the hierarchical segmentation system 106 assigns each semantic level to a particular color and colorizes the mask corresponding to that semantic level within the graphical user interface 502.

FIG. 5B illustrates a graphical user interface used by the hierarchical segmentation system 106 to display a mask based on a semantic-level mode in accordance with one or more embodiments. In one or more embodiments, a semantic-level mode includes a designation that establishes a semantic level to be displayed. In particular, in some embodiments, a semantic-level mode indicates the semantic level to be displayed, causing a mask corresponding to that semantic level to be displayed. For instance, in some implementations, a semantic-level model indicates a user-defined semantic level or a default semantic level.

For instance, FIG. 5B illustrates a graphical user interface 520 displayed on a client device 522. The hierarchical segmentation system 106 provides, within the graphical user interface 520, a selectable option 524 for selecting a semantic-level mode. As illustrated, upon detecting a selection of the selectable option 524, the hierarchical segmentation system 106 provides a plurality of additional selectable options 526a-526d (e.g., via a dropdown menu as illustrated or via a pop-up window). Further, as shown, the hierarchical segmentation system 106 provides a visual indication 528 of the currently selected semantic-level mode. In some embodiments, upon detecting a user selection of a selectable option corresponding to another semantic mode, the hierarchical segmentation system 106 updates the graphical user interface 520 to provide the visual indication 528 in association with the selected semantic mode.

As further shown in FIG. 5B, the hierarchical segmentation system 106 provides, for display within the graphical user interface 520, a mask 530 corresponding to the semantic level of the currently selected semantic-level mode. In some cases, upon detecting a user selection of a selectable option corresponding to another semantic mode, the hierarchical segmentation system 106 updates the graphical user interface 520 to provide the mask corresponding to the semantic level of the selected semantic-level mode. In one or more embodiments, the hierarchical segmentation system 106 provides the mask 530 for display to indicate that the mask 530 is active. In other words, the hierarchical segmentation system 106 provides the mask 530 to indicate that the mask 530 is currently usable for editing the digital image (e.g., modifying the visual element corresponding to the mask 530). Upon detecting a user selection of another semantic-level mode, the hierarchical segmentation system 106 activates the mask corresponding to the semantic level of the selected semantic-level model.

To illustrate, in one or more embodiments, when providing a mask for display within the graphical user interface 520, the hierarchical segmentation system 106 determines the current semantic-level model associated with the graphical user interface 520. The hierarchical segmentation system 106 determines the semantic level corresponding to the current semantic-level mode and further determines the generated mask that corresponds to that semantic level. Thus, the hierarchical segmentation system 106 provides the mask for display within the graphical user interface 520. In some cases, the hierarchical segmentation system 106 detects user input establishing another semantic-level mode as the current semantic-level mode. In response to the user input, the hierarchical segmentation system 106 updates the graphical user interface 520 to display the mask for the semantic level corresponding to the selected semantic-level mode.

FIG. 5C illustrates a graphical user interface used by the hierarchical segmentation system 106 to enable a user of a client device to cycle through generated masks in accordance with one or more embodiments. FIG. 5C illustrates a graphical user interface 540 displayed on a client device 542. As shown, the hierarchical segmentation system 106 provides a mask 544 for display within the graphical user interface 540.

As further shown in FIG. 5C, the hierarchical segmentation system 106 receives scroll input 546 (e.g., via the client device 542). In one or more embodiments, scroll input includes user input for cycling through the members of a set. In particular, in some embodiments, scroll input includes user input for cycling through a generated hierarchy of masks one mask at a time. For instance, in some implementations, scroll input includes user input to progress from a current semantic level to another semantic level that is one level higher or lower. To illustrate, in some cases, the hierarchical segmentation system 106 receives the scroll input 546 by receiving a user interaction with an arrow key, by receiving a user interaction with a mouse wheel, or by receiving a touch input indicative of an intent to scroll (e.g., a swiping motion).

As shown by FIG. 5C, in response to receiving the scroll input 546, the hierarchical segmentation system 106 updates the graphical user interface 540 to display another mask 548. In particular, the hierarchical segmentation system 106 updates the graphical user interface 540 to display the mask 548 that is one level hierarchically higher than the semantic level corresponding to the mask 544 (e.g., upon determining the scroll input 546 indicates an intent to go higher in the semantic hierarchy) or one level hierarchically lower than the semantic level corresponding to the mask 544 (e.g., upon determining the scroll input 546 indicates an intent to go lower in the semantic hierarchy). Thus, in some implementations, the hierarchical segmentation system 106 generates a hierarchy of masks, displays one mask at a time via the graphical user interface 540, and enables a user of the client device 542 to efficiently view the various generated masks using additional user inputs.

As mentioned, one or more embodiments of the hierarchical segmentation system 106 operate with improved flexibility when compared to many conventional systems. In particular, embodiments of the hierarchical segmentation system 106 provide improved segmentation by targeting a semantic hierarchy to generate a plurality of masks for designated semantic levels. Researchers evaluated the performance of various embodiments of the hierarchical segmentation system 106 with existing systems to confirm the improved performance.

In particular, the researchers compared the performance of (i) an embodiment of the hierarchical segmentation system 106 trained using training data generated via an object-labeled dataset, (ii) an embodiment of the hierarchical segmentation system 106 trained using hierarchy-aware pixel sampling and a contrastive-based loss, and (iii) the segment anything model (SAM) described by Alexander Kirillov et al., Segment Anything, arXiv: 2304.02643, 2023. The researchers compared the performance of each tested model on images from multiple image datasets using multiple metrics, including object intersection over union, part intersection over union, and an additional metric defined below:

$$C V R ( M ) := \frac{1}{( \begin{matrix}\vert M \vert \\ 2\end{matrix} )} [ {\sum }_{i < j} 𝟙 [ IoU ( M [ i ] , M [ j ] ) < τ ] ] \qquad ( 2 )$$

In equation 2, M represents the set of masks generated for the same object,

$$\begin{matrix}\vert M \vert \\ 2\end{matrix}$$

represents the number of possible mask combinations, and τ represents the IoU threshold. In some instances, τ takes on a value (0,1) where 0 indicates that all parts had the same object mask within tolerance τ and 1 indicates that no parts had the same object mask within tolerance τ. Thus, the CVR metric defined by equation 2 measures the error of a neural networks in distinguishing between different parts of the same object or different subparts of the same part. In these tests, both embodiments of the hierarchical segmentation system 106 performed better than the SAM model in all metrics, sometimes showing significant improvement. The embodiment of the hierarchical segmentation system 106 trained using the hierarchy-aware pixel sampling and the contrastive-based loss showed the best overall improvement. As such, embodiments of the hierarchical segmentation system 106 are shown to more flexibly and consistently target a hierarchy of masks for objects selected within a digital image.

Turning now to FIG. 6, additional detail will now be provided regarding various components and capabilities of the hierarchical segmentation system 106. FIG. 6 illustrates the hierarchical segmentation system 106 implemented by the computing device 600 (e.g., the server device(s) 102 and/or one of the client devices 110a-110n discussed above with reference to FIG. 1). Additionally, the hierarchical segmentation system 106 is part of the image editing system 104. As shown, in one or more embodiments, the hierarchical segmentation system 106 includes, but is not limited to, a segmentation training engine 602, a segmentation engine 604, a user interface manager 606, and data storage 608 (which includes a segmentation neural network 610 and training input 612).

As just mentioned, and as illustrated in FIG. 6, the hierarchical segmentation system 106 includes the segmentation training engine 602. In one or more embodiments, the segmentation training engine 602 trains a segmentation neural network to generate a hierarchy of masks for an object selected within a digital image (e.g., for one or more pixels selected within the object). For instance, in some cases, the segmentation training engine 602 generates training data for use in the training, such as by generating part-level, subpart-level, and/or group-level training labels from a dataset of labeled objects. In some cases, the segmentation training engine 602 further trains the segmentation neural network using hierarchy-aware pixel selection and/or a contrastive-based loss function. Thus, in some cases, the segmentation training engine 602 trains the segmentation neural network to learn tokens having parent-child relationships and thus corresponding to different semantic levels.

Additionally, as shown in FIG. 6, the hierarchical segmentation system 106 includes the segmentation engine 604. In one or more embodiments, the segmentation engine 604 implements a segmentation neural network to generate a hierarchy of masks for an object selected from a digital image. In particular, in some embodiments, in response to receiving a user selection of one or more pixels within an object portrayed in a digital image, the segmentation engine 604 uses a segmentation neural network to generate a plurality of masks where each mask is part of a semantic hierarchy. In some cases, the segmentation engine 604 uses the segmentation neural network to generate the masks based on internally generated tokens having parent-child relationships.

As shown in FIG. 6, the hierarchical segmentation system 106 further includes the user interface manager 606. In one or more embodiments, the user interface manager 606 presents generated masks for display on a client device. The user interface manager 606 uses various graphical user interface configurations in various implementations. For instance, in some cases, the user interface manager 606 presents the masks simultaneously (e.g., using an editing window to display an active mask and using a viewing window to display other masks), presents a mask that corresponds to a current semantic-level mode, or presents the masks one-at-a-time but cycles through the masks upon receiving scroll input.

As further shown in FIG. 6, the hierarchical segmentation system 106 includes data storage 608. In particular, data storage 608 includes the segmentation neural network 610 and training input 612.

Each of the components 602-612 of the hierarchical segmentation system 106 optionally include software, hardware, or both. For example, in some cases, the components 602-612 include one or more instructions stored on a computer-readable storage medium and executable by processors of one or more computing devices, such as a client device or server device. When executed by the one or more processors, the computer-executable instructions of one or more embodiments of the hierarchical segmentation system 106 cause the computing device(s) to perform the methods described herein. Alternatively, in some instances, the components 602-612 include hardware, such as a special-purpose processing device to perform a certain function or group of functions. Alternatively, in certain implementations, the components 602-612 of the hierarchical segmentation system 106 include a combination of computer-executable instructions and hardware.

Furthermore, in one or more embodiments, the components 602-612 of the hierarchical segmentation system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 602-612 of the hierarchical segmentation system 106 are implemented as a stand-alone application, such as a desktop or mobile application. Furthermore, in some cases, the components 602-612 of the hierarchical segmentation system 106 are implemented as one or more web-based applications hosted on a remote server device. Alternatively, or additionally, the components 602-612 of the hierarchical segmentation system 106 are implemented in a suite of mobile device applications or “apps.” For example, in one or more embodiments, the hierarchical segmentation system 106 comprises or operates in connection with digital software applications such as ADOBE® PHOTOSHOP®, ADOBE® ILLUSTRATOR®, or ADOBE® CREATIVE CLOUD®. The foregoing are either registered trademarks or trademarks of Adobe Inc. in the United States and/or other countries.

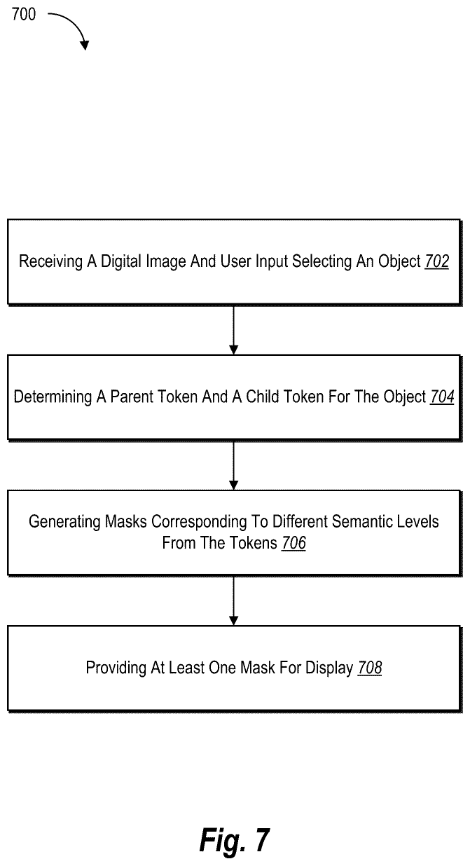

FIGS. 1-6, the corresponding text, and the examples provide a number of different methods, systems, devices, and non-transitory computer-readable media of the hierarchical segmentation system 106. In addition to the foregoing, one or more embodiments are also described in terms of flowcharts comprising acts for accomplishing the particular result, as shown in FIG. 7. In one or more embodiments, FIG. 7 is performed with more or fewer acts. Further, in some embodiments, the acts are performed in different orders. Additionally, in some cases, the acts described herein are repeated or performed in parallel with one another or in parallel with different instances of the same or similar acts.

FIG. 7 illustrates a flowchart of a series of acts 700 for generating a hierarchy of masks for a selected object in a digital image in accordance with one or more embodiments. FIG. 7 illustrates acts according to one embodiment, but alternative embodiments omit, add to, reorder, and/or modify any of the acts shown in FIG. 7. In some implementations, the acts of FIG. 7 are performed as part of a computer-implemented method. Alternatively, in some embodiments, a non-transitory computer-readable medium stores instructions thereon that, when executed by at least one processor, cause the at least one processor to perform operations comprising the acts of FIG. 7. In some embodiments, a system performs the acts of FIG. 7. For example, in some cases, a system includes one or more memory devices. The system further includes one or more processors coupled to the one or more memory devices that cause the system to perform operations comprising the acts of FIG. 7.

The series of acts 700 includes an act 702 for receiving a digital image and user input selecting an object. For example, in one or more embodiments, the act 702 involves receiving a digital image and user input selecting one or more pixels within an object portrayed in the digital image.

The series of acts 700 also includes an act 704 for determining a parent token and a child token for the object. For instance, in some embodiments, the act 704 involves determining, using a segmentation neural network and based on the user input, a parent token corresponding to a first semantic level for the object and a child token corresponding to a second semantic level for the object that is hierarchically lower than the first semantic level.

Additionally, the series of acts 700 includes an act 706 for generating masks corresponding to different semantic levels from the tokens. To illustrate, in some cases, the act 706 involves generating, using the segmentation neural network and from the parent token and the child token, a first mask that corresponds to the first semantic level and a second mask that corresponds to the second semantic level.

In one or more embodiments, generating the first mask that corresponds to the first semantic level comprises generating an object-level mask for the object; and generating the second mask that corresponds to the second semantic level comprises generating a part-level mask for the object, a subpart-level mask for the object, or a group-level mask for the object.

The series of acts 700 further includes an act 708 for providing at least one mask for display. For example, in some instances, the act 708 involves providing, for display, at least one of the first mask or the second mask. Indeed, in some cases, the hierarchical segmentation system 106 provides the at least one mask for display on a client device, such as a client device from which the digital image and user input were received.

In one or more embodiments, providing, for display, at least one of the first mask or the second mask comprises: determining that a semantic-level mode associated with a graphical user interface displaying the digital image corresponds to the first semantic level; and providing, for display within the graphical user interface, in response to determining that the semantic-level mode corresponds to the first semantic level, the first mask corresponding to the first semantic level. In some cases, the hierarchical segmentation system 106 further detects additional user input establishing the second semantic level as the semantic-level mode associated with the graphical user interface; and updates, in response to the additional user input, the graphical user interface to display the second mask corresponding to the second semantic level.

In some embodiments, providing, for display, at least one of the first mask or the second mask comprises: providing the first mask for display within an editing window displaying the digital image; and providing the second mask for display within a viewing window positioned adjacent to the editing window within a graphical user interface.

In some cases, the hierarchical segmentation system 106 further generates, using the segmentation neural network, a third mask that corresponds to a third semantic level for the object and a fourth mask that corresponds to a fourth semantic level for the object. As such, in some instances, providing at least one of the first mask or the second mask for display comprises providing, for display, at least one of the first mask, the second mask, the third mask, or the fourth mask.

In one or more embodiments, receiving the user input selecting the one or more pixels within the object comprises receiving the user input selecting pixels associated with a first part of the object; and determining, using the segmentation neural network, the parent token corresponding to the first semantic level and the child token corresponding to the second semantic level comprises determining, using the segmentation neural network, the parent token corresponding to the object as a whole and the child token corresponding to the first part of the object. Additionally, in some embodiments, the hierarchical segmentation system 106 further receives additional user input selecting additional pixels associated with a second part of the object; determines, using the segmentation neural network and in response to receiving the additional user input, an additional parent token corresponding to the object as the whole and an additional child token corresponding to the second part of the object; and generates, using the segmentation neural network, a third mask that corresponds to the object as the whole and a fourth mask that corresponds to the second part of the object.

In some instances, receiving the user input selecting the one or more pixels within the object comprises receiving, via a graphical user interface displaying the digital image, a single click selecting the one or more pixels; and determining, using the segmentation neural network, the parent token and the child token based on the user input comprises determining, using the segmentation neural network, the parent token and the child token in response to the single click selecting the one or more pixels.

To provide an illustration, in some embodiments, the hierarchical segmentation system 106 generates, using a first segmentation neural network, a plurality of segmentation outputs from training images having a first set of training labels corresponding to a first semantic level of objects portrayed in the training images; determines a second set of training labels corresponding to a second semantic level of the objects portrayed in the training images by comparing the plurality of segmentation outputs to the objects; generates, using a second segmentation neural network, a set of predicted masks for an object portrayed in a training image from the training images based on a training input selecting a pixel within the object; and updates parameters of the second segmentation neural network based on comparing the set of predicted masks to a first training label from the first set of training labels and a second training label from the second set of training labels.

In some embodiments, the hierarchical segmentation system 106 further generates, using the second segmentation neural network, a first set of tokens corresponding to the set of predicted masks for the object based on the training input selecting the pixel within a first part of the object; generates, using the second segmentation neural network, a second set of tokens corresponding to an additional set of predicted masks for the object based on an additional training input selecting an additional pixel within a second part of the object; and updates the parameters of the second segmentation neural network by comparing the first set of tokens corresponding to the first part of the object and the second set of tokens corresponding to the second part of the object. In some cases, updating the parameters of the second segmentation neural network by comparing the first set of tokens and the second set of tokens comprises updating the parameters of the second segmentation neural network by comparing the first set of tokens and the second set of tokens using a contrastive-based loss function. Further, in some instances, generating, using the second segmentation neural network, the first set of tokens based on the training input selecting the pixel within the first part of the object comprises generating, using the second segmentation neural network, a first parent token corresponding to the object and a first child token corresponding to the first part of the object; and generating, using the second segmentation neural network, the second set of tokens based on the additional training input selecting the additional pixel within the second part of the object comprises generating, using the second segmentation neural network, a second parent token corresponding to the object and a second child token corresponding to the second part of the object.

In some implementations, generating the plurality of segmentation outputs from the training images having the first set of training labels corresponding to the first semantic level of the objects portrayed in the training images comprises generating the plurality of segmentation outputs from the training images having a set of object-level training labels for the objects; and determining the second set of training labels corresponding to the second semantic level of the objects portrayed in the training images by comparing the plurality of segmentation outputs to the objects comprises determining a set of part-level training labels for parts of the objects by comparing the plurality of segmentation outputs to the objects. In some cases, determining the set of part-level training labels for the parts of the objects by comparing the plurality of segmentation outputs to the objects comprises determining a segmentation output corresponds to a part of an object portrayed in a training image based on the segmentation output occupying a subset of space within the object.

Additionally, in some embodiments, generating the plurality of segmentation outputs from the training images having the first set of training labels corresponding to the first semantic level of the objects portrayed in the training images comprises generating the plurality of segmentation outputs from the training images having a set of object-type training labels for the objects; and the operations further comprise determining one or more group-level training labels for a training image based on determining that at least two object-type training labels for at least two objects portrayed in the training image correspond to a same object type.

To provide another illustration, in one or more embodiments, the hierarchical segmentation system 106 receives a digital image and user input detected via a graphical user interface of a client device, the user input selecting one or more pixels within an object portrayed in the digital image; generates, using a segmentation neural network and in response to the user input, a plurality of masks that correspond to a plurality of semantic levels for the object based on one or more parent tokens and one or more child tokens corresponding to the plurality of semantic levels; provides, for display within the graphical user interface, a first mask from the plurality of masks that corresponds to a first semantic level for the object; and provides, for display within the graphical user interface and in response to receiving additional user input, one or more additional masks from the plurality of masks that correspond to one or more additional semantic levels for the object.

In some embodiments, providing the one or more additional masks for display within the graphical user interface in response to receiving the additional user input comprises providing, for display within the graphical user interface, an additional mask that corresponds to a semantic level that is one level up or one level down from the first semantic level in response to receiving scroll input. In some cases, providing the one or more additional masks for display within the graphical user interface in response to receiving the additional user input comprises providing, for display within the graphical user interface, an additional mask that corresponds to an additional semantic level in response to the additional user input establishing the additional semantic level as a semantic-level mode for the graphical user interface. Additionally, in some instances, the hierarchical segmentation system 106 further modifies the digital image using at least one mask from the plurality of masks.

Some embodiments of the present disclosure comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, in some cases, one or more of the processes described herein are implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

In one or more embodiments, computer-readable media include various available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, one or more embodiments of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which is usable to store desired program code means in the form of computer-executable instructions or data structures and which is accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some cases, transmissions media includes a network and/or data links which are usable to carry desired program code means in the form of computer-executable instructions or data structures and which is accessible by a general purpose or special purpose computer. Combinations of the above should also be included within the scope of computer-readable media.

Further, upon reaching various computer system components, program code means in the form of computer-executable instructions or data structures is transferrable automatically from transmission media to non-transitory computer-readable storage media (devices) (or vice versa). For example, in some cases, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some cases, non-transitory computer-readable storage media (devices) are included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. In some instances, the computer executable instructions are, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that one or more embodiments are practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. Some implementations are practiced in distributed system environments where local and remote computer systems, which are linked (either by hardwired data links, wireless data links, or by a combination of hardwired and wireless data links) through a network, both perform tasks. In some implementations, in a distributed system environment, program modules are located in both local and remote memory storage devices.

Some embodiments of the present disclosure are implemented in cloud computing environments. In this description, “cloud computing” is defined as a model for enabling on-demand network access to a shared pool of configurable computing resources. For example, in some cases, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some embodiments, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of an example computing device 800 that is configured to perform one or more of the processes described above in some embodiments. One will appreciate that one or more computing devices, such as the computing device 800, represent the computing devices described above (e.g., the server device(s) 102 and/or the client devices 110a-110n) in some implementations. In one or more embodiments, the computing device 800 is a mobile device (e.g., a mobile telephone, a smartphone, a PDA, a tablet, a laptop, a camera, a tracker, a watch, a wearable device). In some embodiments, the computing device 800 is a non-mobile device (e.g., a desktop computer or another type of client device). Further, in certain embodiments, the computing device 800 is a server device that includes cloud-based processing and storage capabilities.

As shown in FIG. 8, the computing device 800 includes one or more processor(s) 802, memory 804, a storage device 806, input/output interfaces 808 (or “I/O interfaces 808”), and a communication interface 810, which are communicatively coupled by way of a communication infrastructure (e.g., bus 812). While the computing device 800 is shown in FIG. 8, the components illustrated in FIG. 8 are not intended to be limiting. Additional or alternative components are used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 retrieve (or fetch) the instructions from an internal register, an internal cache, memory 804, or a storage device 806 and decode and execute them in some implementations.

The computing device 800 includes memory 804, which is coupled to the processor(s) 802. In certain cases, the memory 804 is used for storing data, metadata, and programs for execution by the processor(s). In some instances, the memory 804 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some embodiments, the memory 804 includes internal or distributed memory.

The computing device 800 includes a storage device 806 including storage for storing data or instructions. As an example, and not by way of limitation, in some cases, the storage device 806 includes a non-transitory storage medium described above. In some embodiments, the storage device 806 includes a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. In one or more embodiments, these I/O interfaces 808 include a mouse, keypad or a keyboard, a touch screen, camera, optical scanner, network interface, modem, other known I/O devices or a combination of such I/O interfaces 808. In some cases, the touch screen is activated with a stylus or a finger.

In one or more embodiments, the I/O interfaces 808 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. In some cases, the graphical data is representative of one or more graphical user interfaces and/or any other graphical content that serves a particular implementation.

The computing device 800 further includes a communication interface 810. In some cases, the communication interface 810 includes hardware, software, or both. The communication interface 810 provides one or more interfaces for communication (such as, for example, packet-based communication) between the computing device and one or more other computing devices or one or more networks. As an example, and not by way of limitation, in some cases, communication interface 810 includes a network interface controller (NIC) or network adapter for communicating with an Ethernet or other wire-based network or a wireless NIC (WNIC) or wireless adapter for communicating with a wireless network, such as a WI-FI. The computing device 800 further includes a bus 812. In some cases, the bus 812 includes hardware, software, or both that connects components of computing device 800 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

Various implementations of the present invention are embodied in other specific forms without departing from its spirit or essential characteristics. The described embodiments are to be considered in all respects only as illustrative and not restrictive. For example, in some embodiments, the methods described herein are performed with less or more steps/acts or the steps/acts are performed in differing orders. Additionally, in some cases, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a digital image and user input selecting one or more pixels within an object portrayed in the digital image;
determining, using a segmentation neural network and based on the user input, a parent token corresponding to a first semantic level for the object and a child token corresponding to a second semantic level for the object that is hierarchically lower than the first semantic level;
generating, using the segmentation neural network and from the parent token and the child token, a first mask that corresponds to the first semantic level and a second mask that corresponds to the second semantic level; and
providing, for display, at least one of the first mask or the second mask.

2. The computer-implemented method of claim 1, wherein:
generating the first mask that corresponds to the first semantic level comprises generating an object-level mask for the object; and
generating the second mask that corresponds to the second semantic level comprises generating a part-level mask for the object, a subpart-level mask for the object, or a group-level mask for the object.

3. The computer-implemented method of claim 1,
further comprising generating, using the segmentation neural network, a third mask that corresponds to a third semantic level for the object and a fourth mask that corresponds to a fourth semantic level for the object,
wherein providing at least one of the first mask or the second mask for display comprises providing, for display, at least one of the first mask, the second mask, the third mask, or the fourth mask.

4. The computer-implemented method of claim 1, wherein:
receiving the user input selecting the one or more pixels within the object comprises receiving the user input selecting pixels associated with a first part of the object; and
determining, using the segmentation neural network, the parent token corresponding to the first semantic level and the child token corresponding to the second semantic level comprises determining, using the segmentation neural network, the parent token corresponding to the object as a whole and the child token corresponding to the first part of the object.

5. The computer-implemented method of claim 4, further comprising:
receiving additional user input selecting additional pixels associated with a second part of the object;
determining, using the segmentation neural network and in response to receiving the additional user input, an additional parent token corresponding to the object as the whole and an additional child token corresponding to the second part of the object; and
generating, using the segmentation neural network, a third mask that corresponds to the object as the whole and a fourth mask that corresponds to the second part of the object.

6. The computer-implemented method of claim 1, wherein:
receiving the user input selecting the one or more pixels within the object comprises receiving, via a graphical user interface displaying the digital image, a single click selecting the one or more pixels; and
determining, using the segmentation neural network, the parent token and the child token based on the user input comprises determining, using the segmentation neural network, the parent token and the child token in response to the single click selecting the one or more pixels.

7. The computer-implemented method of claim 1, wherein providing, for display, at least one of the first mask or the second mask comprises:
determining that a semantic-level mode associated with a graphical user interface displaying the digital image corresponds to the first semantic level; and
providing, for display within the graphical user interface, in response to determining that the semantic-level mode corresponds to the first semantic level, the first mask corresponding to the first semantic level.

8. The computer-implemented method of claim 7, further comprising:
detecting additional user input establishing the second semantic level as the semantic-level mode associated with the graphical user interface; and
updating, in response to the additional user input, the graphical user interface to display the second mask corresponding to the second semantic level.

9. The computer-implemented method of claim 1, wherein providing, for display, at least one of the first mask or the second mask comprises:
providing the first mask for display within an editing window displaying the digital image; and
providing the second mask for display within a viewing window positioned adjacent to the editing window within a graphical user interface.

10. A system comprising:
one or more memory devices; and
one or more processors coupled to the one or more memory devices that cause the system to perform operations comprising:
generating, using a first segmentation neural network, a plurality of segmentation outputs from training images having a first set of training labels corresponding to a first semantic level of objects portrayed in the training images;
determining a second set of training labels corresponding to a second semantic level of the objects portrayed in the training images by comparing the plurality of segmentation outputs to the objects;
generating, using a second segmentation neural network, a set of predicted masks for an object portrayed in a training image from the training images based on a training input selecting a pixel within the object; and
updating parameters of the second segmentation neural network based on comparing the set of predicted masks to a first training label from the first set of training labels and a second training label from the second set of training labels.

11. The system of claim 10 wherein the operations further comprise:
generating, using the second segmentation neural network, a first set of tokens corresponding to the set of predicted masks for the object based on the training input selecting the pixel within a first part of the object;
generating, using the second segmentation neural network, a second set of tokens corresponding to an additional set of predicted masks for the object based on an additional training input selecting an additional pixel within a second part of the object; and
updating the parameters of the second segmentation neural network by comparing the first set of tokens corresponding to the first part of the object and the second set of tokens corresponding to the second part of the object.

12. The system of claim 11, wherein updating the parameters of the second segmentation neural network by comparing the first set of tokens and the second set of tokens comprises updating the parameters of the second segmentation neural network by comparing the first set of tokens and the second set of tokens using a contrastive-based loss function.

13. The system of claim 11, wherein:
generating, using the second segmentation neural network, the first set of tokens based on the training input selecting the pixel within the first part of the object comprises generating, using the second segmentation neural network, a first parent token corresponding to the object and a first child token corresponding to the first part of the object; and
generating, using the second segmentation neural network, the second set of tokens based on the additional training input selecting the additional pixel within the second part of the object comprises generating, using the second segmentation neural network, a second parent token corresponding to the object and a second child token corresponding to the second part of the object.

14. The system of claim 10, wherein:
generating the plurality of segmentation outputs from the training images having the first set of training labels corresponding to the first semantic level of the objects portrayed in the training images comprises generating the plurality of segmentation outputs from the training images having a set of object-level training labels for the objects; and
determining the second set of training labels corresponding to the second semantic level of the objects portrayed in the training images by comparing the plurality of segmentation outputs to the objects comprises determining a set of part-level training labels for parts of the objects by comparing the plurality of segmentation outputs to the objects.

15. The system of claim 14, wherein determining the set of part-level training labels for the parts of the objects by comparing the plurality of segmentation outputs to the objects comprises determining a segmentation output corresponds to a part of an object portrayed in a training image based on the segmentation output occupying a subset of space within the object.

16. The system of claim 10, wherein:
generating the plurality of segmentation outputs from the training images having the first set of training labels corresponding to the first semantic level of the objects portrayed in the training images comprises generating the plurality of segmentation outputs from the training images having a set of object-type training labels for the objects; and
the operations further comprise determining one or more group-level training labels for a training image based on determining that at least two object-type training labels for at least two objects portrayed in the training image correspond to a same object type.

17. A non-transitory computer-readable medium storing instructions thereon that, when executed by at least one processor, cause the at least one processor to perform operations comprising:
receiving a digital image and user input detected via a graphical user interface of a client device, the user input selecting one or more pixels within an object portrayed in the digital image;
generating, using a segmentation neural network and in response to the user input, a plurality of masks that correspond to a plurality of semantic levels for the object based on one or more parent tokens and one or more child tokens corresponding to the plurality of semantic levels;
providing, for display within the graphical user interface, a first mask from the plurality of masks that corresponds to a first semantic level for the object; and
providing, for display within the graphical user interface and in response to receiving additional user input, one or more additional masks from the plurality of masks that correspond to one or more additional semantic levels for the object.

18. The non-transitory computer-readable medium of claim 17, wherein providing the one or more additional masks for display within the graphical user interface in response to receiving the additional user input comprises providing, for display within the graphical user interface, an additional mask that corresponds to a semantic level that is one level up or one level down from the first semantic level in response to receiving scroll input.

19. The non-transitory computer-readable medium of claim 17, wherein the operations further comprise modifying the digital image using at least one mask from the plurality of masks.

20. The non-transitory computer-readable medium of claim 17, wherein providing the one or more additional masks for display within the graphical user interface in response to receiving the additional user input comprises providing, for display within the graphical user interface, an additional mask that corresponds to an additional semantic level in response to the additional user input establishing the additional semantic level as a semantic-level mode for the graphical user interface.
